(19) United States
(12) Patent Application Publication
(10) Pub. No.: US 2015/0135141 A1
(43) Pub. Date: May 14, 2015

(54) METHOD AND APPARATUS FOR CREATING A CONTROL INTERFACE OF A PERIPHERAL DEVICE

(71) Applicant: Tencent Technology (Shenzhen) Company Limited, Shenzhen City (CN)

(72) Inventors: Xiangru LI, Shenzhen City (CN); Xuan LUO, Shenzhen City (CN)

(21) Appl. No.: 14/599,057

(22) Filed: Jan. 16, 2015

Related U.S. Application Data
(63) Continuation of application No. PCT/CN2013/000874, filed on Jul. 22, 2013.

(30) Foreign Application Priority Data
Jul. 20, 2012 (CN) 201210252539.7

(51) Int. Cl. G06F 13/10; G06F 3/0482; G06F 3/0481

(52) U.S. Cl. CPC G06F 13/10; G06F 3/04817; G06F 3/0482
USPC 715/835; 710/10

(57) ABSTRACT

The present disclosure discloses a method and apparatus for creating a control interface of a peripheral device, which pertains to the art of computer. The method includes: when the peripheral device is connected to a terminal, generating ingress of the peripheral device on an interface of the terminal; receiving a first control command submitted by a user through the ingress for the peripheral device on an interface, acquiring a system control program and a control interface to which the peripheral device corresponds; creating the control interface for the peripheral device according to the device identifier and the system control program to which the peripheral device corresponds. The apparatus comprises a generation module, an acquisition module and a creating module. Efficiency of controlling the peripheral device is improved by the present disclosure.

### CROSS-REFERENCE TO RELATED APPLICATIONS

This application is a continuation application under 35 U.S.C. §111(a) claiming priority under 35 U.S.C. §120 and 365(c) to International Application No. PCT/CN/2013/000874, Filed Jul. 22, 2013, which claims the priority benefit of Chinese Patent Application No. 201210252539.7 filed on Jul. 20, 2012 and entitled “METHOD AND APPARATUS FOR CREATING A CONTROL INTERFACE OF A PERIPHERAL DEVICE”, the content of which are incorporated herein in their entirety.

### FIELD OF THE DISCLOSURE

Title of disclosure relates to the field of computer, and particularly, to a method and apparatus for creating a control interface of a peripheral device.

### BACKGROUND

A peripheral device of a computer is a device that may be inserted to and be polled out the computer, currently, relatively common peripheral devices comprises a U-disk, a mobile hard drive, a projector, an infrared device and a Bluetooth device, etc.

Currently, when inserting a peripheral device to a computer, a user needs to open a plurality of ingresses to find a control interface of the peripheral device, and then perform control on the peripheral device within the control interface. For example, when a user is inserting a U-disk to a computer, the user needs to open the control interface of the computer disks to finding the driver to which the U-disk corresponds, then can the user open the driver to open the control interface that the U-disk corresponds to perform control on the corresponding U-disk.

In the process of implementing the present disclosure, the inventors have found that the prior art at least has the following problems:

when inserting a peripheral device to a computer, a user needs to open a plurality of ingresses to find a control interface of the peripheral device and to perform control on the peripheral device, which makes control of the peripheral device less efficient.

### SUMMARY OF THE DISCLOSURE

In order to prove efficiency of a peripheral device, a method and apparatus for creating a control interface of a peripheral device is provide, the technical solution are as follows:

a method for creating a control interface for a peripheral device, comprising:

when the peripheral device is connected to a terminal, generating ingress of the peripheral device on an interface of the terminal;

receiving a first control command submitted by a user through the ingress for the peripheral device on an interface, acquiring a system control program and a control interface to which the peripheral device corresponds;

creating the control interface for the peripheral device according to the device identifier and the system control program to which the peripheral device corresponds.

an apparatus for creating a control interface for a peripheral device, comprising:

a generation module, for generating ingress of a peripheral device on an interface of the terminal when the peripheral device is connected to the terminal;

an acquisition module, for acquiring a system control program and a control interface to which the peripheral device corresponds, upon receiving a first control command submitted by a user through the ingress for the peripheral device on the interface of the terminal; and

a creating module, for creating a control interface of the peripheral device according to the device identifier and the system control program to which the peripheral device corresponds.

In an embodiment of the present disclosure, when a peripheral device is connected to a terminal, ingress of the peripheral device is generated on an interface of the terminal; a first control command submitted through the ingress for the peripheral device is received on an interface, a system control program and a control interface to which the peripheral device corresponds are acquired; a control interface of the peripheral device is created according to the device identifier and the system control program to which the peripheral device corresponds. Therefore, a control interface for control a peripheral device may be opened directly through an icon for the peripheral device, without need to open multiple ingresses and to open the control interface for control the peripheral device by multiple operations, and efficiency of controlling the peripheral device is improved.

### DESCRIPTION OF THE DRAWINGS

FIG. 1 is a flow diagram showing a method for creating a control interface of a peripheral device provided by Embodiment 1 of the present disclosure.

FIG. 2 is a flow diagram showing a method for creating a control interface of a peripheral device provided by Embodiment 2 of the present disclosure.

FIG. 3 is a flow diagram showing a method for creating a control interface of a peripheral device provided by Embodiment 3 of the present disclosure.

FIG. 4 is a schematic diagram showing the structure of an apparatus for creating a control interface of a peripheral device provided by Embodiment 4 of the present disclosure.

FIG. 5 is a schematic diagram showing the structure of an acquisition module included in the apparatus according to Embodiment 4 of the present disclosure.

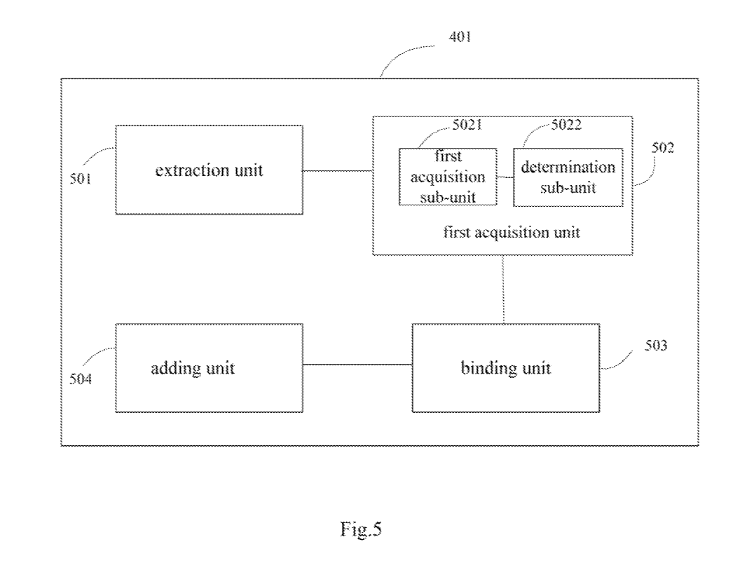

FIG. 6 is a schematic diagram showing the structure of an acquisition module included in the apparatus according to Embodiment 4 of the present disclosure.

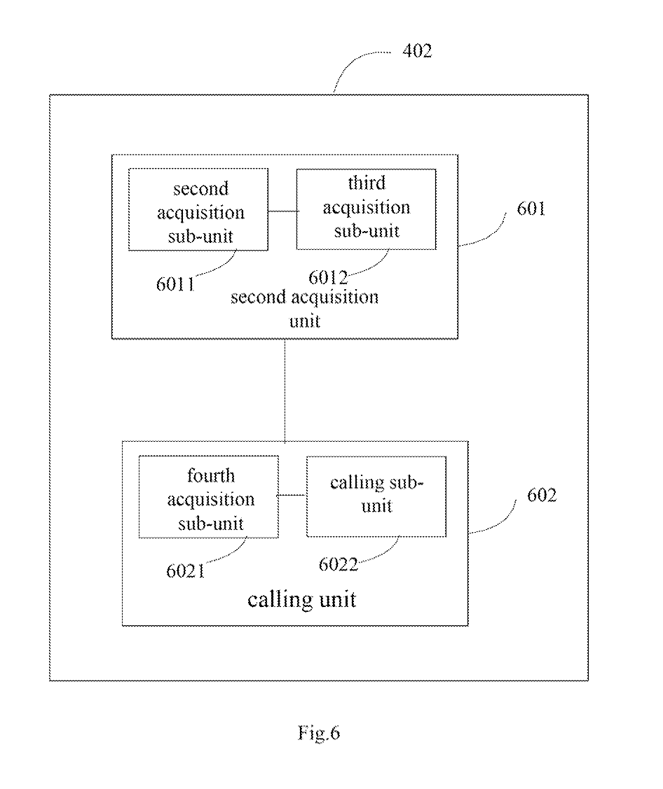

### DETAILED EMBODIMENTS

In order to make the objects, technical solutions and advantages of the disclosure more apparent, the disclosure will be further illustrated in details in connection with accompanying figures and embodiments hereinafter.

A method and apparatus for creating a control interface of a peripheral device provided by various embodiments of the present disclosure may be implemented on terminals of a plurality of kinds. The terminal may be a fixed terminal, or it may be a mobile terminal. Examples of a terminal that may be used by embodiments comprise but are not limited to: tablets (including, but not limited to an Apple iPad or other touch screen devices running Apple's iOS Microsoft Surface, other touch screen devices running the Windows operating system and tablet devices running Android operating system), mobile phones, smart phones (including, but not limited to an Apple iPhone, a Windows Mobile, or other smart phones running Windows or Pocket PC and other smart phones running Android operating system, BlackBerry operating system or Symbian operating system), e-readers (including, but not limited to, Amazon Kindle and the Barnes & Noble Nook), portable computers (including, but not limited to, computers running Apple's Mac operating system, Windows operating system, Android operating system and/or Google Chrome operating system), or a vehicle device running any one of the operating systems above or any other operating systems, all of which are common for those skilled in the art.

### EMBODIMENT 1

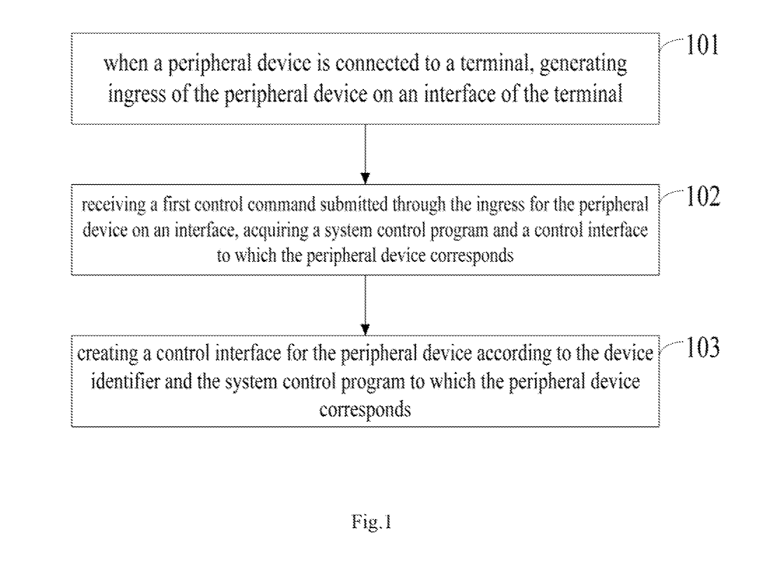

As shown in FIG. 1, a method for creating a control interface of a peripheral device is provided by an embodiment of the present disclosure.

Step S101: when a peripheral device is connected to a terminal, ingress of the peripheral device is generated on an interface of the terminal;

Specifically, an installing message of the peripheral device broadcasted by an operating system is received, a device identifier is extracted from the installing message of the peripheral device, ingress for the peripheral device is created on an interface of the terminal, and the device identifier for the peripheral device is bound to the ingress for the peripheral device.

Wherein the device identifier for the peripheral device is used to uniquely identify the peripheral device, the device identifier may be a title or a drive for the peripheral device.

In various embodiments of the present disclosure, a peripheral device refers to any devices apart from the terminal itself, it may be an accessory device or an auxiliary device connected to the terminal so as to extend functions of the terminal system. In certain embodiments of the present disclosure, a peripheral device may comprise a device which may be inserted to and polled out from a terminal, for example, a U-disk, a mobile hard drive, a projector, an infrared device and a Bluetooth device, etc.

Step S102: a first control command submitted through the ingress for the peripheral device is received on an interface, and a system control program and a control interface to which the peripheral device corresponds are acquired.

Wherein the operating system comprises system control programs to which each kind of peripheral devices corresponds, a system control program to which a peripheral device corresponds is for creating a control interface of the peripheral device.

Step S103: creating a control interface of the peripheral device according to the device identifier and the system control program to which the peripheral device corresponds.

Wherein the control interface of the peripheral device is for controlling the peripheral device, and the control interface comprises ingresses to which functions of the peripheral devices correspond therein.

In an embodiment of the present disclosure, when a peripheral device is connected to a terminal, ingress of the peripheral device is generated on an interface of the terminal; a first control command submitted through the ingress for the peripheral device is received on an interface, a system control program and a control interface to which the peripheral device corresponds are acquired; a control interface of the peripheral device is created according to the device identifier and the system control program to which the peripheral device corresponds. Therefore, a control interface for control a peripheral device may be opened directly through an icon for the peripheral device, without need to open multiple ingresses and to open the control interface for control the peripheral device by multiple operations, and efficiency of controlling the peripheral device is improved.

In an embodiment of the present disclosure, the ingress may be an object or a channel, a peripheral device is controlled by controlling the object or by entering into the channel, for example, to open a certain function of the peripheral device. For example, when a peripheral U-disk is connected, three controllable (e.g., controlled by way of clicking, touching and the like) icons for the U-disk may be generated on a interaction interface of a terminal, the three icon may be “open”, “pop-up” and “check the virus” respectively, which correspond to the ingress opening the U-disk, the ingress popping up the U-disk and the ingress checking the virus. An icon of a U-disk device may be clicked directly, for example, ingress checking the virus may be clicked to open a control interface for controlling checking-virus operation on the U-disk.

### EMBODIMENT 2

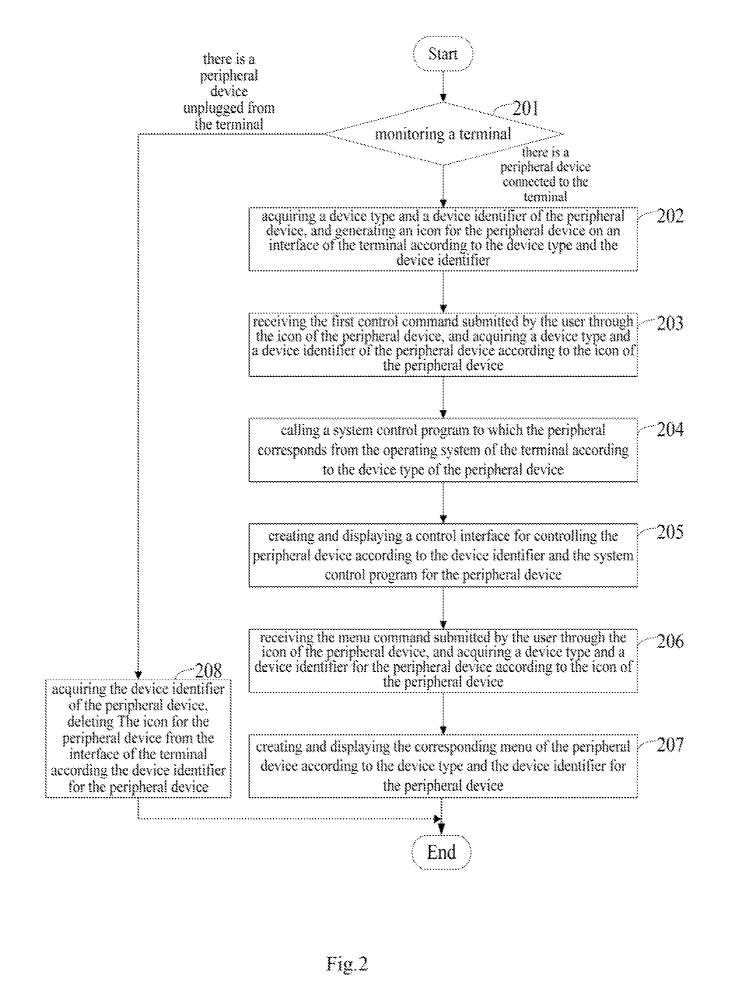

A method for creating a control interface of a peripheral device is provided by an embodiment of the present disclosure. Wherein when inserting a peripheral device to a terminal, a user generates ingress for controlling the peripheral device on an interface of the terminal by the method provided by the embodiment, and creates a control interface for controlling the peripheral device through the ingress, so as to improve efficiency of controlling the peripheral device. Wherein in the embodiment, ingress of a peripheral device may be displayed as controllable (e.g., controlled by way of clicking, touching and the like) icons for the peripheral device. See FIG. 2, the method comprises:

Step S201: a terminal is monitored, if it is monitored out that a peripheral device is connected to the terminal, then Step S202 is performed, and if it is monitored out that a peripheral device is unplugged from the terminal, then Step S208 is performed.

Specifically, a listening window is created, a system message broadcasted by an operating system of the terminal through the listening window is received, if the system message broadcasted by the operating system of the terminal is a device installing message, then it is monitored out that there is a peripheral device connected to the terminal, and if the system message broadcasted by the operating system of the terminal is a device uninstalling message, then it is monitored out that there is a peripheral device unplugged from the terminal.

Wherein an operating system of a terminal may generate a system message, and broadcast the generated message to windows included in the terminal. When there is a peripheral device connected to the terminal, the operating system of the terminal generates a system message to which the peripheral device corresponds, the system is a device installing message and the device installing message at least comprises a device type and a device identifier of the peripheral device, then the device installing message is broadcasted to windows included in the terminal; when there is a peripheral device unplugged from the terminal, the operating system of the terminal generates a system message to which the peripheral device corresponds, the system is a device uninstalling message and the device installing message at least comprises a device type and a device identifier of the peripheral device, then the device uninstalling message is broadcasted to windows included in the terminal.

For example, when a user inserts a U-disk to a terminal, an operating system of the terminal generates a device installing message to which the U-disk corresponds the device installing message at least comprises device type of U-disk and device identifier of ID1, then the device installing message is broadcasted to windows included in the terminal.

When receiving the device installing message broadcasted by the operating system of the terminal, if it is monitored out that a peripheral device is connected to the terminal, then perform Step S202.

Step S202: a device type and a device identifier of the peripheral device are acquired, and an icon for the peripheral device is generated on an interface of the terminal according to the device type and the device identifier.

Specifically, the device type and the device identifier for the peripheral device are extracted from the device installing message for the peripheral device, an icon for the peripheral device is acquired according to the device type for the peripheral device and the stored correspondence between icons and device types, and the device identifier for the peripheral device is bound to an icon for the peripheral device and then the icon for the peripheral device is added to the interface of the terminal.

Wherein acquiring an icon for the peripheral device according to the device type for the peripheral device and the stored correspondence between icons and device types may specifically be:

corresponding icon(s) is acquired from the correspondence between icons and stored device types based on device type for the peripheral device, if the acquired icon(s) comprises one icon, then the acquired one icon is determined as the icon for the peripheral device, if the acquires icon(s) comprises a plurality of icons, then one icon is selected from the plurality of icons randomly, and the selected icon is determined as the icon for the peripheral device.

Wherein one or more icons may be pre-defined for each kind of peripheral devices, and each device type for the peripheral device and one or more icons to which each kind of peripheral device corresponds may be stored in a correspondence relationship between device types and icons.

For example, an icon 1 may be pre-defined for a U-disk, device type of a U-disk “U-disk” and the icon 1 may be stored in a correspondence relationship between device types and icons as shown in Table 1; icons 2 and 3 may be pre-defined for a mobile hard disk, device type of a mobile hard disk “Mobile Hard Disk” and the icons 2 and 3 may be stored in a correspondence relationship between device types and icons as shown in Table 1; similar processes are performed on every other kind of peripheral devices.

TABLE 1

| DEVICE TYPE | ICON |
|---|---|
| U-disk | icon 1 |
| Mobile Hard Disk | icon 2 and icon 3 |
| . . . | . . . |

Wherein in Step S201, if it is monitored out that a peripheral device is connected to the terminal and that the peripheral device is a U-disk, then the information that a device type of the U-disk is “U-disk” and that device identifier of the U-disk is ID1 are extracted from the corresponding device installing message. Corresponding icon 1 is acquired from the correspondence relationship between device types and icons as shown in Table 1, and the device identifier ID1 is bound to the acquired icon 1, and then adding the bound icon 1 to an interface of the terminal.

Wherein upon an icon of a peripheral device being displayed on an interface of a terminal, a user may select an icon for the peripheral device, and submit a first control command through the icon for the peripheral device. Wherein the user may perform single or double click on an icon of a certain peripheral device through an input device such as a mouse, the input device may generate and submit the first control command.

Correspondingly, according to the following Steps S203-S205, a receipt user acquires a control interface to which the peripheral device corresponds by the first control command submitted through the icon for the peripheral device; thereby the user may control the peripheral device through the control interface.

Step S203: the first control command submitted by the user through the icon for the peripheral device is received, and a device type and a device identifier of the peripheral device are acquired according to the icon for the peripheral device.

Specifically, the first control command submitted by the user through the icon for the peripheral device is received, the device identifier for the peripheral device that is bound to the icon for the peripheral device is acquired, and device type of the peripheral device is acquired from the stored correspondence relationship between device types and icons.

For example, a user selects an icon 1 for a U-disk on an interface of a terminal by a mouse, and submits a control command by double click on the icon 1.

Correspondingly, the control command submitted by the user through the icon 1 for the U-disk is received, ID1 is acquired as the device identifier that is bound to the icon 1, and device type of the U-disk is acquired from the correspondence relationship between device types and icons as shown in Table 1 according to the icon 1 as “U-disk”.

Step S204: a system control program to which the peripheral corresponds is called from the operating system of the terminal according to the device type of the peripheral device.

Specifically, a storage path of the system control program to which the peripheral corresponds is acquired from the stored correspondence relationship between device types and storage paths according to the device type of the peripheral device, and the system control program to which the peripheral corresponds is called from the operating system of the terminal according to the acquired storage path.

Wherein the operating system of the terminal comprises system control programs for every peripheral device, for any peripheral device, when the system control program to which the peripheral corresponds is run, a control interface for controlling the peripheral device is generated. With respect to different operating systems, storage paths for storing system control program for each peripheral device may be different. Further, in the embodiment, the correspondence relationship between storage paths and device types to which each kind of operating system corresponds are predefined by a person skilled in the art.

Accordingly, before this step being performed, the type of the operating system of the terminal is acquired, and the correspondence relationship between storage paths and device types to which the operating system corresponds is acquired according to the type of the operating system, and the correspondence relationship between the storage paths and the device type to which the operating system corresponds is stored.

Step S205: a control interface for controlling the peripheral device is created and displayed according to the device identifier and the system control program for the peripheral device.

Wherein, a user may control a peripheral device in a control interface for controlling the peripheral device.

Optionally, upon an icon for a peripheral device being displayed on an interface of the terminal, a user may select one icon for the peripheral device; submit a menu command through the icon for the peripheral device; wherein the user may submit the menu command by double clicking on a certain icon of a peripheral device using a mouse.

Accordingly, the menu command submitted by the user through the icon for the peripheral device is received, and the menu to which the peripheral device corresponds is acquired according to the following steps S206 and S207.

Step S206: the menu command submitted by the user through the icon for the peripheral device is received, and a device type and a device identifier for the peripheral device are acquired according to the icon for the peripheral device.

Specifically, the menu command submitted by the user through the icon for the peripheral device is received, a device identifier for the peripheral device which is bound to the icon for the peripheral device is acquired, and the device type for the peripheral device is acquired from the stored correspondence relationship between device types and icons

Step S207: the corresponding menu of the peripheral device are created and displayed according to the device type and the device identifier for the peripheral device.

Specifically, corresponding menu item is acquired from the stored correspondence relationship between devices and menu items according to the device type of the peripheral device, the device identifier for the peripheral device is bound to each of the acquired menu items and creating a menu list, each of the bound menu item is filed into the created menu list to obtain a menu to which the peripheral device corresponds, and the menu to which the peripheral device corresponds is displayed.

Step S208: the device identifier of the peripheral device is acquired, the icon for the peripheral device is deleted from the interface of the terminal according the device identifier for the peripheral device, and the operation is ended.

Specifically, device identifier for the peripheral device is extracted from a device uninstalling message for the peripheral device, the icon to which the device identifier for the peripheral device is bound is found from the icons displayed in the interface of the terminal, the icon is the icon for the peripheral device, and the icon for the peripheral device is deleted from the interface of the terminal.

Wherein tooltips may be predefined for each kind of peripheral devices, then the tooltips and device identifiers for each kind of peripheral devices are stored in the correspondence relationship between device identifiers and tooltips.

Further, upon the device identifier for the peripheral device being acquired in step S202, the tooltip to which the peripheral device corresponds may further be acquired from the stored correspondence relationship between device identifiers and tooltips according to the device identifier for the peripheral device, a tooltip window may be created, the tooltip to which the peripheral device corresponds is uploaded in the tooltip window, and the tooltip window is displayed.

Further, before displaying the tooltip window, a setting button may be created in the tooltip window, and the device identifier and device type for the peripheral device are bound to the setting button.

Further, when a user submits a setting command through the settings button, the setting command is received, and the device identifier and device type for the peripheral device which are bound to the setting button are acquired. Corresponding storage address is acquired from the stored correspondence relationship between storage addresses and device types according to the device type of the peripheral device. Corresponding system control program is called according to the storage address, and the system control program is run according to the device identifier for the peripheral device, and a control interface for controlling the peripheral device is created.

In an embodiment of the present disclosure, when a peripheral device is connected to a terminal, ingress of the peripheral device is generated on an interface of the terminal; a first control command submitted through the ingress for the peripheral device is received on an interface, a system control program and a control interface to which the peripheral device corresponds are acquired; a control interface of the peripheral device is created according to the device identifier and the system control program to which the peripheral device corresponds. Therefore, a control interface for control a peripheral device may be opened directly through an icon for the peripheral device, without need to open multiple ingresses and to open the control interface for control the peripheral device by multiple operations, and efficiency of controlling the peripheral device is improved.

### EMBODIMENT 3

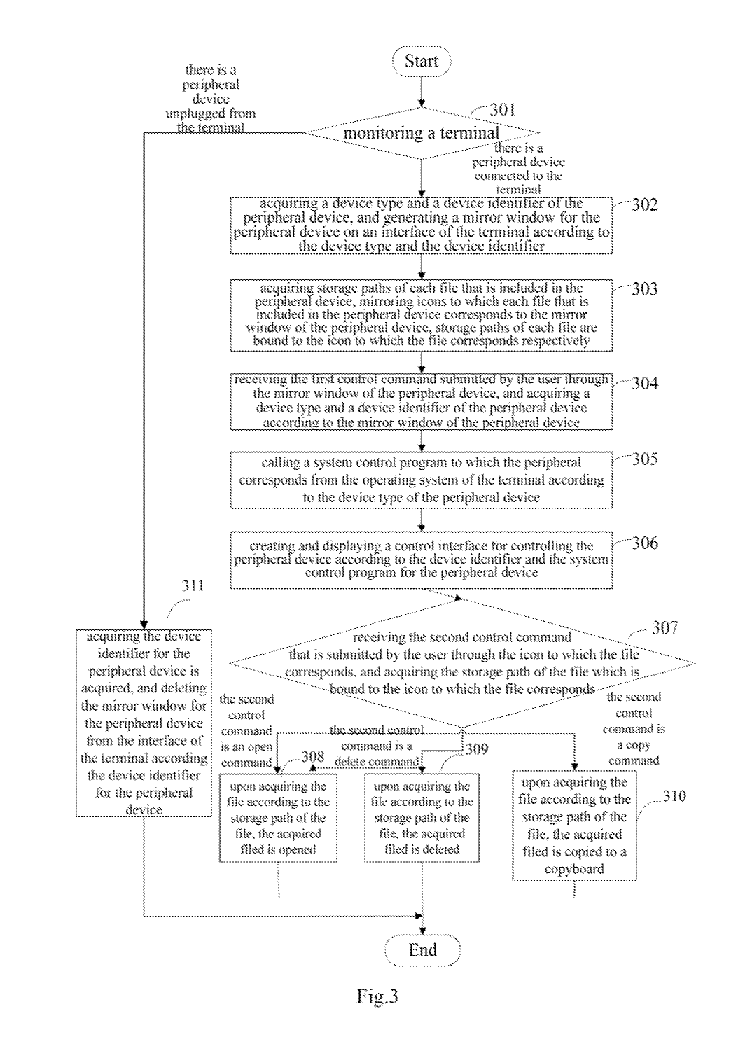

An embodiment of the present disclosure provides a method for creating a control interface of a peripheral device. Wherein a peripheral device is connected to a terminal by a user, ingress for controlling the peripheral device is generated on the interface of the terminal through the method provided by the embodiment. The control interface for controlling the peripheral device is generated through the ingress, and the efficiency of controlling the peripheral device is improved. Wherein, in the embodiment, the ingress for the peripheral device may be a mirror window for the peripheral device. As shown in FIG. 3, the method comprises:

Step S301: a terminal is monitored, if it is monitored out that a peripheral device is connected to the terminal, then Step S302 is performed, and if it is monitored out that a peripheral device is unplugged from the terminal, then Step S211 is performed.

Wherein the specific process may be referred to corresponding contents of step S201, it is unnecessary to go into details here.

Step S302: a device type and a device identifier of the peripheral device are acquired, and a mirror window for the peripheral device is generated on an interface of the terminal according to the device type and the device identifier.

Specifically, the device type and the device identifier for the peripheral device are extracted from the device installing message for the peripheral device, the mirror window for the peripheral device is created in the interface of the terminal, and he device type and the device identifier for the peripheral device are bound to the mirror window for the peripheral device.

Step S303, storage paths of each file that is included in the peripheral device are acquired, icons to which each file that is included in the peripheral device corresponds are mirrored to the mirror window of the peripheral device, storage paths of each file are bound to the icon to which the file corresponds respectively.

Wherein upon creating the mirror window for the peripheral device, a user may submit a first control command by performing single or double click on a mirror window of a certain peripheral device through an input device such as a mouse.

Correspondingly, according to the following Steps S304-S306, a receipt user acquires a control interface to which the peripheral device corresponds by the first control command submitted through the mirror window of the peripheral device; thereby the user may control the peripheral device through the control interface.

Step S304: the first control command submitted by the user through the mirror window of the peripheral device is received, and a device type and a device identifier of the peripheral device are acquired according to the mirror window of the peripheral device.

Specifically, the first control command submitted by the user through the mirror window of the peripheral device is received, the device type and the device identifier for the peripheral device that are bound to the mirror window for the peripheral device are acquired.

Step S305: a system control program to which the peripheral corresponds is called from the operating system of the terminal according to the device type of the peripheral device.

Specifically, a storage path of the system control program to which the peripheral corresponds is acquired from the stored correspondence relationship between device types and storage paths according to the device type of the peripheral device, and the system control program to which the peripheral corresponds is called from the operating system of the terminal according to the acquired storage path.

Wherein the operating system of the terminal comprises system control programs for every peripheral device, for any peripheral device, when the system control program to which the peripheral corresponds is run, a control interface for controlling the peripheral device is generated. With respect to different operating systems, storage paths for storing system control program for each peripheral device may be different. Further, in the embodiment, the correspondence relationship between storage paths and device types to which each kind of operating system corresponds are predefined by a person skilled in the art.

Accordingly, before this step being performed, the type of the operating system of the terminal is acquired, and the correspondence relationship between storage paths and device types to which the operating system corresponds is acquired according to the type of the operating system, and the correspondence relationship between the storage paths and the device type to which the operating system corresponds is stored.

Step S306: a control interface for controlling the peripheral device is created and displayed according to the device identifier and the system control program for the peripheral device.

Wherein, a user may control a peripheral device in a control interface for controlling the peripheral device.

Wherein, a user may further control files that are included in the peripheral device on the mirror window for the peripheral device. If the user wants to control a certain file, then he or she may perform single or double click on the icon to which the file corresponds through an input device such as a mouse, to submit a second control command.

Step S307: the second control command that is submitted by the user through the icon to which the file corresponds is received, and the storage path of the file which is bound to the icon to which the file corresponds is acquired.

If the second control command is an open command, then Step S308 is performed; if the second control command is a delete command, then Step S309 is performed; and if the second control command is a copy command, then Step S310 is performed.

Step S308: the file is acquired according to the storage path of the file, and the acquired filed is opened.

Step S309: the file is acquired according to the storage path of the file, and the acquired filed is deleted.

Step S310: the file is acquired according to the storage path of the file, and the acquired filed is copied to a copyboard.

Wherein when a user selects a storage area that stores the file, the file included in the copyboard is stored in the storage area.

Step S311: the device identifier for the peripheral device is acquired, and the mirror window for the peripheral device is deleted from the interface of the terminal according the device identifier for the peripheral device, and then operation is ended.

Specifically, device identifier for the peripheral device is extracted from a device uninstalling message for the peripheral device, the mirror window to which the device identifier for the peripheral device is bound is found from the mirror windows displayed in the interface of the terminal, the mirror window is the mirror window for the peripheral device, and the mirror window for the peripheral device is deleted from the interface of the terminal.

In an embodiment of the present disclosure, when a peripheral device is connected to a terminal, a mirror window for the peripheral device is generated on an interface of the terminal; a first control command submitted through the mirror window for the peripheral device is received on an interface, a system control program and a control interface to which the peripheral device corresponds are acquired; a control interface of the peripheral device is created according to the device identifier and the system control program to which the peripheral device corresponds. Therefore, a control interface for control a peripheral device may be opened directly through an icon for the peripheral device, without need to open multiple ingresses and to open the control interface for control the peripheral device by multiple operations, and efficiency of controlling the peripheral device is improved.

### EMBODIMENT 4

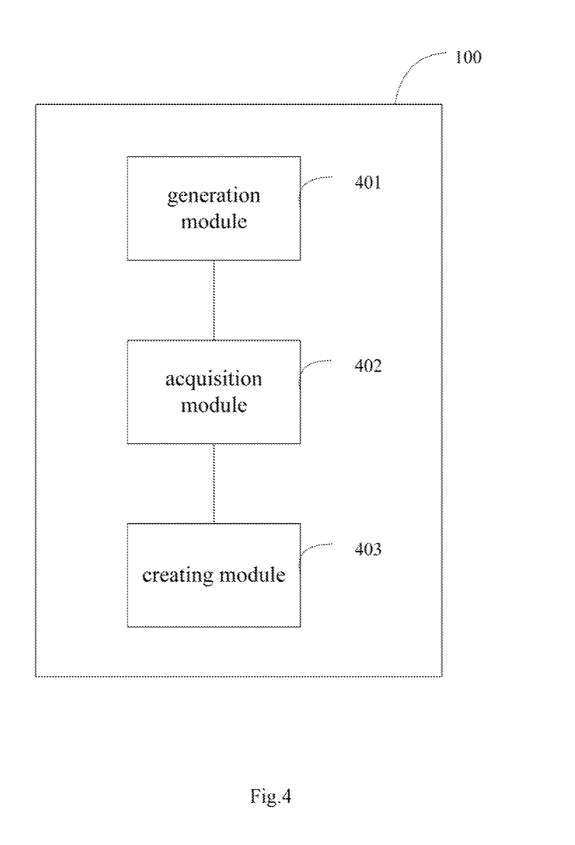

As shown in FIG. 4, an embodiment of the present disclosure provides an apparatus 400 for creating a control interface of a peripheral device, comprising:

a generation module 401, for generating ingress of a peripheral device on an interface of the terminal when the peripheral device is connected to the terminal;

an acquisition module 402, for acquiring a system control program and a control interface to which the peripheral device corresponds, upon receiving a first control command submitted by a user through the ingress for the peripheral device on the interface of the terminal; and

a creating module 403, for creating a control interface of the peripheral device according to the device identifier and the system control program to which the peripheral device corresponds.

Wherein, the ingress of the peripheral device is a mirror window.

The apparatus 400 further comprises:

a mirror module, for mirroring icons to which each of the files included in the peripheral device corresponds to the mirror window;

a first acquisition sub-module, for acquiring storage paths for each of the files;

a binding module, for binding, in the mirror window, the storage paths for each of the files to icons to which each of the files corresponds respectively.

The apparatus 400 further comprises:

a first receiving sub-module, for receiving a second control command submitted by the user through the icon to which the file corresponds;

a second acquisition sub-module, for acquiring the storage path for the file that is bound to the icon to which the file corresponds; and

an execution module, for executing a control operation to which the second control command corresponds according to the storage path for the file.

Wherein the execution module comprises:

an opening unit, if the second control command is an open command, then the opening unit opens the acquired filed according to the storage path of the file;

a deleting unit, if the second control command is a delete command, then the deleting unit deletes the acquired filed according to the storage path of the file, and

a copying unit, if the second control command is a copy command, then the copying unit copies the acquired filed to a copyboard according to the storage path of the file.

Wherein, the ingress of the peripheral device is an icon for the peripheral device.

Wherein, the generation module 401 comprises:

an extraction unit 501, for extracting a device type and a device identifier from an installing message of a peripheral device when the installing message of the peripheral device broadcasted by an operating system is received;

a first acquisition unit 502, for acquiring an icon for the peripheral device is acquired according to the device type for the peripheral device and the stored correspondence between icons and device types;

a binding unit 503, for binding the device identifier for the peripheral device to an icon for the peripheral device; and

an adding unit 504, for adding the icon for the peripheral device to the interface of the terminal.

The first acquisition unit 502 further comprises:

a first acquisition sub-unit 5021, for acquiring an icon for the peripheral device from the stored correspondence between icons and device types according to the device type for the peripheral device;

a determination sub-unit 5022, for that if the acquired icon(s) comprises one icon, then determining the acquired one icon as the icon for the peripheral device, and if the acquires icon(s) comprises a plurality of icons, then selecting one icon from the plurality of icons randomly and determining the selected icon as the icon for the peripheral device.

Wherein the acquisition module 402 comprises:

a second acquisition unit 601, for acquiring a device type and a device identifier of the peripheral device are acquired according to the icon for the peripheral device;

a calling unit 602, for calling a system control program to which the peripheral corresponds from the operating system of the terminal according to the device type of the peripheral device.

The second acquisition unit 601 further comprises:

a second acquisition sub-unit 6011, for acquiring the device identifier for the peripheral device that is bound to the icon for the peripheral device;

a third acquisition sub-unit 6012, for acquiring device type of the peripheral device from the stored correspondence relationship between device types and icons.

The calling unit 602 further comprises:

a fourth acquisition sub-unit 6021, for acquiring a storage path of the system control program to which the peripheral corresponds from the stored correspondence relationship between device types and storage paths according to the device type of the peripheral device, and

a calling sub-unit 6022, for calling the system control program to which the peripheral corresponds from the operating system of the terminal according to the storage path acquired from the correspondence relationship between device types and storage paths.

Wherein, the creating module 403 comprises: a generation unit, for generating and displaying a control interface for controlling the peripheral device according to the device identifier and the system control program for the peripheral device.

The apparatus 400 further comprises:

a third acquisition sub-module, for acquiring the device identifier for the peripheral device that is bound to the icon for the peripheral device upon receiving the menu command submitted by the user through the icon for the peripheral device on the interface for the terminal;

a menu creating module, for creating and displaying the corresponding menu of the peripheral device according to the device type and the device identifier for the peripheral device.

Wherein, the third acquisition sub-module comprises:

a fifth acquisition sub-unit, for acquiring the device identifier for the peripheral device that is bound to the icon for the peripheral device upon receiving the menu command submitted by the user through the icon for the peripheral device on the interface for the terminal;

a sixth acquisition sub-unit, for acquiring corresponding menu item from the stored correspondence relationship between devices and menu items according to the device type of the peripheral device.

Wherein, the menu creating module comprises:

a fifth acquisition unit, for acquiring corresponding menu item from the stored correspondence relationship between devices and menu items according to the device type of the peripheral device;

a binding sub-unit, for binding the device identifier for the peripheral device to each of the acquired menu items;

a creating sub-unit, for creating a menu list;

a filling unit, for filing each of the bound menu item into the created menu list to obtain a menu to which the peripheral device corresponds; and

a display unit, for displaying the menu to which the peripheral device corresponds.

The apparatus 400 further comprises:

a monitoring module, for creating a listening window, receiving a system message broadcasted by an operating system of the terminal through the listening window, wherein if the system message broadcasted by the operating system of the terminal is a device installing message, then it is monitored out that there is a peripheral device connected to the terminal, and if the system message broadcasted by the operating system of the terminal is a device uninstalling message, then it is monitored out that there is a peripheral device unplugged from the terminal.

The apparatus 400 further comprises:

a fourth acquisition sub-module, for acquiring the device identifier for the peripheral device from the uninstalling message for the peripheral device when it is monitored out that there is a peripheral device unplugged from the terminal; and

a deleting module, for deleting icons for the peripheral device from the interface of the terminal according to the device identifier for the peripheral device.

In an embodiment of the present disclosure, when a peripheral device is connected to a terminal, ingress of the peripheral device is generated on an interface of the terminal; a first control command submitted through the ingress for the peripheral device is received on an interface, a system control program and a control interface to which the peripheral device corresponds are acquired; a control interface of the peripheral device is created according to the device identifier and the system control program to which the peripheral device corresponds. Therefore, a control interface for control a peripheral device may be opened directly through an icon for the peripheral device, without need to open multiple ingresses and to open the control interface for control the peripheral device by multiple operations, and efficiency of controlling the peripheral device is improved.

The apparatus provided by the embodiments above is only an example for illustration with respect of divisions of the aforementioned respective functional modules. But in actual application, the functions described above may be allocated to different functional modules to perform according to the needs. That is, internal structure of the apparatus may be divided into different functional modules so as to accomplish all or part of the functions described above.

According to some embodiments of the present disclosure, one of ordinary skill in the art could understand that all of part of the steps of the above embodiments may be realized by hardware, or they may be realized by programs instructing the hardware to perform so. The program may be stored in a computer-readable storage medium; the storage medium may be a read only memory, a magnetic disk or an optical disk, etc.

According to other embodiments of the present disclosure, a computer program (including program code) may be employed to construct the apparatus for creating a control interface for a peripheral device as shown in FIG. 4, and to realize an image synthesis method according to embodiments of the present disclosure. The computer program is capable of performing the method for creating a control interface for a peripheral device as shown in FIGS. 1-3 on a general computing devices, for example, a computer comprising processing elements and storage elements such as a central processing unit (CPU), a random access memory (RAM), a read only memory (ROM) and the like.

The above described embodiments are merely preferred embodiments of the disclosure, but not intended to limit the disclosure. Any modifications, equivalent alternations and improvements that are made within the spirit and scope of the disclosure should be included in the protection scope of the disclosure.

What is claimed is:

1. A method for creating a control interface for a peripheral device, comprising:
when the peripheral device is connected to a terminal, generating ingress of the peripheral device on an interface of the terminal;
receiving a first control command submitted by a user through the ingress for the peripheral device on an interface, acquiring a system control program and a control interface to which the peripheral device corresponds; and
creating the control interface for the peripheral device according to the device identifier and the system control program to which the peripheral device corresponds.

2. The method according to claim 1, wherein the ingress of the peripheral device is a mirror window, and the method further comprises:
mirroring icons to which each of the files included in the peripheral device corresponds to the mirror window;
acquiring storage paths for each of the files; and
binding, in the mirror window, the storage paths for the files to icons to which the files correspond.

3. The method according to claim 2, wherein the method further comprises:
receiving a second control command submitted by the user through the icon to which the file corresponds;
acquiring the storage path for the file that is bound to the icon to which the file corresponds; and
executing a control operation to which the second control command corresponds according to the storage path for the file.

4. The method according to claim 3, wherein the step of executing a control operation to which the second control command corresponds according to the storage path for the file comprises the following steps:
if the second control command is an open command, then opening the acquired filed according to the storage path of the file;
if the second control command is a delete command, then deleting the acquired filed according to the storage path of the file, and
if the second control command is a copy command, then copying the acquired filed to a copyboard according to the storage path of the file.

5. The method according to claim 1, wherein the ingress of the peripheral device is an icon for the peripheral device, and
the step of generating ingress of the peripheral device on the interface of the terminal comprises the following steps:
extracting the device type and the device identifier for the peripheral device from a device installing message for the peripheral device upon receiving the device installing message for the peripheral device broadcasted by the operating system;
acquiring the icon for the peripheral device according to the device type for the peripheral device and the stored correspondence between icons and device types;
binding the device identifier for the peripheral device to the icon for the peripheral device; and
adding the icon for the peripheral device to the interface of the terminal.

6. The method according to claim 5, wherein the step of acquiring the icon for the peripheral device according to the device type for the peripheral device and the stored correspondence between icons and device types comprises the following steps:
acquiring corresponding icon(s) from the correspondence between icons and stored device types based on device type for the peripheral device, if the acquired icon(s) comprises one icon, then determining the acquired one icon as the icon for the peripheral device,
if the acquires icon(s) comprises a plurality of icons, then one icon is selected from the plurality of icons randomly, and then determining the selected icon as the icon for the peripheral device.

7. The method according to claim 1, wherein the ingress of the peripheral device is an icon for the peripheral device, and
the step of acquiring a system control program and a control interface to which the peripheral device corresponds comprises the following steps:
acquiring the device type and the device identifier of the peripheral device according to the icon for the peripheral device; and
calling a system control program to which the peripheral corresponds from the operating system of the terminal according to the device type of the peripheral device.

8. The method according to claim 7, wherein the step of acquiring the device type and the device identifier of the peripheral device according to the icon for the peripheral device comprises the following steps:
acquiring the device identifier for the peripheral device that is bound to the icon for the peripheral device, and
acquiring the device type of the peripheral device from the stored correspondence relationship between device types and icons.

9. The method according to claim 7, wherein the step of calling a system control program to which the peripheral corresponds from the operating system of the terminal according to the device type of the peripheral device comprises the following steps:
acquiring a storage path of the system control program to which the peripheral corresponds from the stored correspondence relationship between device types and storage paths according to the device type of the peripheral device, and
calling the system control program to which the peripheral corresponds from the operating system of the terminal according to the acquired storage path.

10. The method according to claim 1, wherein the step of creating the control interface for the peripheral device according to the device identifier and the system control program to which the peripheral device corresponds comprises the following steps:
running the system control program to which the peripheral device corresponds according to the device identifier for the peripheral device, creating and displaying a control interface for controlling the peripheral device.

11. The method according to claim 5, wherein the method further comprises:
acquiring the device identifier and the device type to which the peripheral device corresponds upon receiving the menu command submitted by the user through the icon of the peripheral device on the interface for the terminal; and creating and displaying the corresponding menu of the peripheral device according to the device type and the device identifier for the peripheral device.

12. The method according to claim 11, wherein the step of creating and displaying the corresponding menu of the peripheral device according to the device type and the device identifier for the peripheral device comprises the following steps:
acquiring corresponding menu item from the stored correspondence relationship between devices and menu items according to the device type of the peripheral device;
binding the device identifier for the peripheral device to each of the acquired menu items;
for creating a menu list;
filing each of the bound menu item into the created menu list to obtain a menu to which the peripheral device corresponds; and
displaying the menu to which the peripheral device corresponds.

13. The method according to claim 12, wherein the method further comprises:
creating a listening window, receiving a system message broadcasted by an operating system of the terminal through the listening window,
if the system message broadcasted by the operating system of the terminal is a device installing message, then it is monitored out that there is a peripheral device connected to the terminal, and
if the system message broadcasted by the operating system of the terminal is a device uninstalling message, then it is monitored out that there is a peripheral device unplugged from the terminal.

14. The method according to claim 13, wherein the method further comprises:
acquiring the device identifier for the peripheral device from the uninstalling message for the peripheral device when it is monitored out that there is a peripheral device unplugged from the terminal; and
deleting icons for the peripheral device from the interface of the terminal according to the device identifier for the peripheral device.

15. An apparatus for creating a control interface for a peripheral device, comprising:
a generation module, for generating ingress of a peripheral device on an interface of the terminal when the peripheral device is connected to the terminal;
an acquisition module, for acquiring a system control program and a control interface to which the peripheral device corresponds, upon receiving a first control command submitted by a user through the ingress for the peripheral device on the interface of the terminal; and
a creating module, for creating a control interface of the peripheral device according to the device identifier and the system control program to which the peripheral device corresponds.

16. The apparatus according to claim 15, wherein the ingress of the peripheral device is a mirror window, and the apparatus further comprises:
a mirror module, for mirroring icons to which each of the files included in the peripheral device corresponds to the mirror window;
a first acquisition sub-module, for acquiring storage paths for each of the files; and
a binding module, for binding, in the mirror window, the storage paths for the files to icons to which the files correspond.

17. The apparatus according to claim 16, wherein the apparatus further comprises:
a first receiving sub-module, for receiving a second control command submitted by the user through the icon to which the file corresponds;
a second acquisition sub-module, for acquiring the storage path for the file that is bound to the icon to which the file corresponds; and
an execution module, for executing a control operation to which the second control command corresponds according to the storage path for the file.

18. The apparatus according to claim 13, wherein the execution module comprises:
an opening unit, if the second control command is an open command, then the opening unit opens the acquired filed according to the storage path of the file;
a deleting unit, if the second control command is a delete command, then the deleting unit deletes the acquired filed according to the storage path of the file, and
a copying unit, if the second control command is a copy command, then the copying unit copies the acquired filed to a copyboard according to the storage path of the file.

19. The apparatus according to claim 15, wherein the ingress of the peripheral device is an icon for the peripheral device, and the generation module comprises:
an extraction unit, for extracting the device type and the device identifier for the peripheral device from a device installing message for the peripheral device upon receiving the device installing message for the peripheral device broadcasted by the operating system;
a first acquisition unit for acquiring the icon for the peripheral device according to the device type for the peripheral device and the stored correspondence between icons and device types;
a binding unit for binding the device identifier for the peripheral device to the icon for the peripheral device; and
an adding unit for adding the icon for the peripheral device to the interface of the terminal.

20. The apparatus according to claim 19, wherein the first acquisition unit comprises:
a first acquisition sub-unit for acquiring corresponding icon(s) from the correspondence between icons and stored device types based on device type for the peripheral device,
a determination sub-unit, for that if the acquired icon(s) comprises one icon, then determining the acquired one icon as the icon for the peripheral device, and if the acquires icon(s) comprises a plurality of icons, then selecting one icon from the plurality of icons randomly and determining the selected icon as the icon for the peripheral device.
